(19) United States
(12) Patent Application Publication
(10) Pub. No.: US 2011/0189562 A1
(43) Pub. Date: Aug. 4, 2011

(54) HYDROGEN GAS GENERATION APPARATUS AND FUEL CELL HAVING THE SAME

(75) Inventors: Yueh-Chang Wu, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/897,796

(22) Filed: Oct. 5, 2010

(30) Foreign Application Priority Data
Jan. 29, 2010 (CN) 201010106779.7

(51) Int. Cl. H01M 8/06

(52) U.S. Cl. 429/423; 422/162

(57) ABSTRACT

The hydrogen gas generation apparatus is adapted for a fuel cell. The hydrogen gas generation apparatus includes a main body, a bimetallic switch, a reserve tank, and a sliding member. The bimetallic switch has one end connected to the main body. The reserve tank is fixed to the main body and adapted to reserve liquid water. The sliding member is slidably disposed on the main body. A solid fuel is fixed to the sliding member. When the bimetallic switch is heated to bend, another end of the bimetallic switch pushes the sliding member toward the reserve tank and the solid fuel reacts with the liquid water in the reserve tank to form hydrogen gas.

### CROSS-REFERENCE TO RELATED APPLICATION

This application claims the priority benefit of China application serial no. 201010106779.7, filed on Jan. 29, 2010. The entirety of the above-mentioned patent application is hereby incorporated by reference herein and made a part of this specification.

### BACKGROUND OF THE INVENTION

1. Field of the Invention

The invention relates to a hydrogen gas generation apparatus and a fuel cell having the hydrogen gas generation apparatus, and more particularly, to a hydrogen gas generation apparatus using a solid fuel and a fuel cell having the hydrogen gas generation apparatus.

2. Description of Related Art

Fuel cells are an electricity generation apparatus that converts a chemical energy directly into an electrical energy. With advantages of low pollution, low noise, high energy density and high energy conversion efficiency over the traditional electricity generation methods, the fuel cells produce a prospective clean energy, which could be utilized in various applications such as portable electronic products, home electricity generation systems, transportations, military devices, aerospace industry as well as small-sized electricity generation systems.

Different types of fuel cells have different applications according to the operation principle and the operation environment. In mobile applications, proton exchange membrane cells (PEMFCs) and direct methanol fuel cells (DMFCs) are main streams, both of which are low temperature fuel cells that perform proton conducting via a proton exchange membrane. For PEMFC, a hydrogen oxidation reaction takes place on an anode catalyst layer to produce hydrogen ions (H+) and electrons (e−) (PEMFC principle), or oxidation of methanol takes place on the anode catalyst layer to produce the hydrogen ions (H+), carbon dioxide (CO₂), and electrons (e−) (DMFC principle). The hydrogen ions are transported across the proton conducting membrane to the cathode. The electrons are transported through an external circuit from anode to cathode, providing power to a load. Oxygen supplied to the cathode reacts (reduction reaction) with the hydrogen ions and electrons on a cathode catalyst layer to produce water. The fuel hydrogen gas for the anode hydrogen oxidation reaction may be obtained through a solid sodium borohydride (NaBH₄) hydrogen storage technology which relies on the reaction of water and the solid sodium borohydride to produce the hydrogen gas.

However, the reaction of the solid sodium borohydride and the water occurs in a one-off manner, which means, once the reaction begins, it does not stop until the solid sodium borohydride or the water is exhausted. Therefore, it would be desirable to achieve a multi-stage reaction.

### SUMMARY OF THE INVENTION

Accordingly, the invention is directed to a hydrogen gas generation apparatus, which could achieve a multi-stage reaction of the solid fuel and the water.

The invention is also directed to a fuel cell which could achieve a multi-stage reaction of the solid fuel and the water of its hydrogen gas generation apparatus.

In one embodiment, the invention provides a hydrogen gas generation apparatus adapted for a fuel cell. The hydrogen gas generation apparatus includes a main body, a bimetallic switch, a reserve tank, and a sliding member. The bimetallic switch has one end connected to the main body. The reserve tank is fixed to the main body and capable of reserving liquid water. The sliding member is slidably disposed on the main body. A solid fuel is fixed to the sliding member. When the bimetallic switch is heated to bend, another end of the bimetallic switch pushes the sliding member to slide toward the reserve tank so the solid fuel reacts with the liquid water in the reserve tank to form hydrogen gas.

In another embodiment, the invention provides a fuel cell including a hydrogen gas generation apparatus, a cell stack, and a guide structure. The hydrogen gas generation apparatus includes a main body, a bimetallic switch, a reserve tank, and a sliding member. The bimetallic switch has one end connected to the main body. The reserve tank is fixed to the main body and adapted to reserve liquid water. The sliding member is slidably disposed on the main body. A solid fuel is fixed to the sliding member. When the bimetallic switch is heated to bend, another end of the bimetallic switch pushes the sliding member to slide toward the reserve tank so the solid fuel reacts with the liquid water in the reserve tank to form hydrogen gas. The guide structure is connected between the hydrogen gas generation apparatus and the cell stack and guides the hydrogen gas form by the reaction between the solid fuel and the liquid water to the cell stack.

In view of the foregoing, in the above-described embodiments of the invention, the sliding member could be moved toward or away from the reserve tank reserving the liquid water under the driving of the bimetallic switch, such that the reaction between the solid fuel fixed to the sliding member and the liquid water could take place to form the hydrogen gas or be halted, thereby achieving a multi-stage reaction.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 illustrates a hydrogen gas generation apparatus according to one embodiment of the invention.

FIG. 2 illustrates the bimetallic switch pushing the sliding member of FIG. 1.

FIG. 3 illustrates the application of the hydrogen gas generation apparatus of FIG. 1 in a fuel cell.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purposes of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

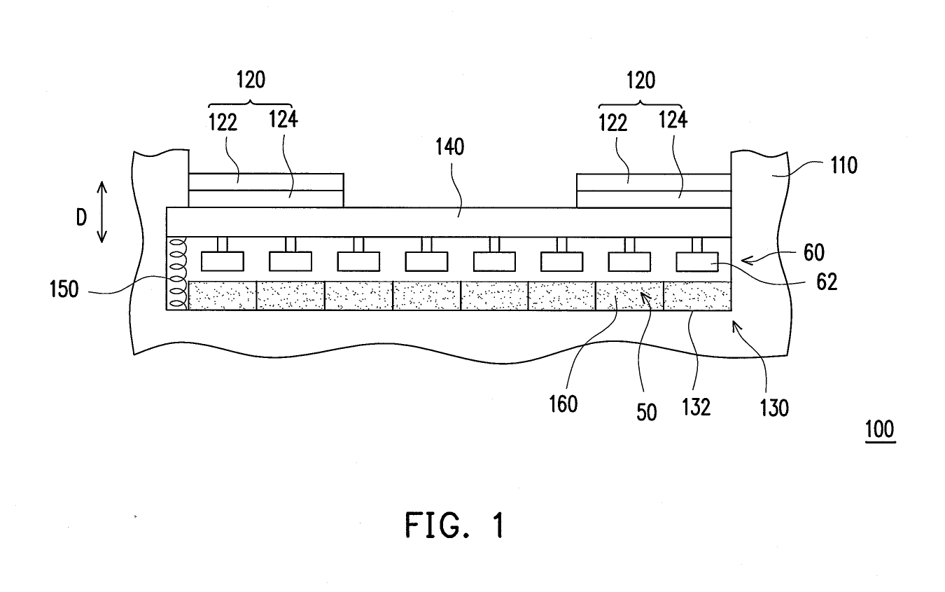

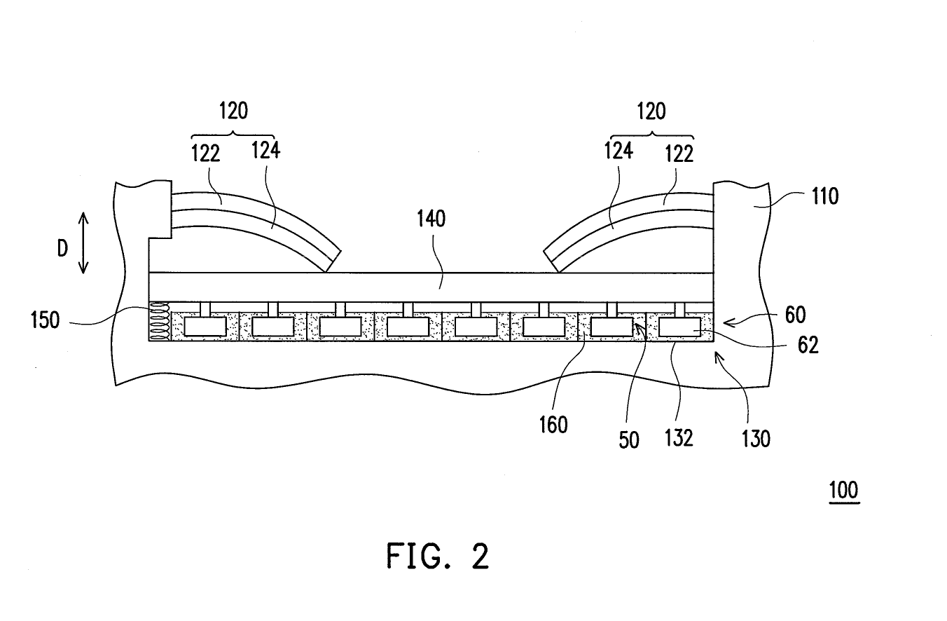

FIG. 1 illustrates a hydrogen gas generation apparatus according to one embodiment of the invention. FIG. 2 illustrates a bimetallic switch pushing a sliding member of FIG. 1. Referring to FIGS. 1 and 2, the hydrogen gas generation apparatus 100 of the embodiment is adapted for a fuel cell to supply the hydrogen gas for the fuel cell anodic reaction. The hydrogen gas generation apparatus 100 includes a main body 110, a bimetallic switch 120, a reserve tank 130, and a sliding member 140.

The bimetallic switch 120 includes one end connected to the main body 110. The reserve tank 130 is fixed to the main body 110 for reserving liquid water 50. The sliding member 140 is slidably disposed on the main body 110 for sliding along a direction D. A solid fuel 60 is fixed to the sliding member 140. When a user wants the solid fuel 60 to react with the liquid water 50 to form the hydrogen gas, the bimetallic switch 120 may be heated to bend thus causing the other end of the bimetallic switch 120 to push the sliding member 140 toward the reserve tank 130 (as shown in FIG. 2), such that the solid fuel 60 reacts with the liquid water 50 in the reserve tank 130 to form the hydrogen gas. In the embodiment, there are two bimetallic switches 120. However, it is noted that any number of the bimetallic switches 120 could be used in alternative embodiments.

When it is desired to halt the reaction between the solid fuel 60 and the liquid water 50 in the reserve tank 130, heating to the bimetallic switches 120 could be stopped such that the bimetallic switches 120 could be restored to the state shown in FIG. 1 and at the same time, the sliding member 140 could be restored to the position shown in FIG. 1, thereby achieving a multi-stage reaction. The sliding member 140 may be restored, for example, under the influence of the elastic force of an elastic member 150 connected between the main body 110 and the sliding member 140. In the embodiment, the elastic member 150 may be, for example, a spring. It is note, that this should not be regarded as limiting and the elastic member 150 could be implanted as other suitable components with elasticity.

Specifically, the bimetallic switch 120 of the embodiment includes a first metal strip 122 and a second metal strip 124 attached to each other. The material of the first metal strip 122 includes invar alloy containing 34% to 50% nickel. The material of the second metal strip 124 includes at least one of brass, nickel, Fe—Ni—Cr alloy, Fe—Ni—Mn alloy, and Mn—Ni—Cu alloy. Because the first metal strip 122 and the second metal strip 124 have different coefficients of thermal expansion, when the bimetallic switch 120 is heated, the first metal strip 122 and the second metal strip 124 experience different degrees of expansion so as to cause a bending deformation of the bimetallic switch 120 (as shown in FIG. 2), thereby pushing the sliding member 140 to slide.

In addition, the reserve tank 130 is partitioned into a plurality of reserve spaces 132 fluidly isolated from one another. These reserve spaces 132 are used to reserve the liquid water 50. The solid fuel 60 includes a plurality of fuel bricks 62 fixed to the sliding member 140. These fuel bricks 62 could be moved into the respective reserve spaces 132, with the sliding of the sliding member 140 to react with the liquid water 50 in these reserve spaces 132 to form the hydrogen gas. By dividing the solid fuel 60 into the multiple fuel bricks 62 to react with the liquid water 50 respectively, the contact area between the solid fuel 60 and the liquid water 50 could be increased thus enhancing the reaction efficiency. In the embodiment, the solid fuel 60 may be, for example, solid sodium borohydride. However, this should not be regarded as limiting and the solid fuel 60 could also be another suitable type of solid fuel.

Furthermore, the hydrogen gas generation apparatus 100 of the embodiment may further include a plurality of water absorbing structures 160. The water absorbing structures 160 are disposed in the reserve spaces 132 respectively to absorb the liquid water 50 to thereby form water jel, such that the liquid water 50 could be kept in the reserve spaces 132 to avoid leakage of the liquid water 50.

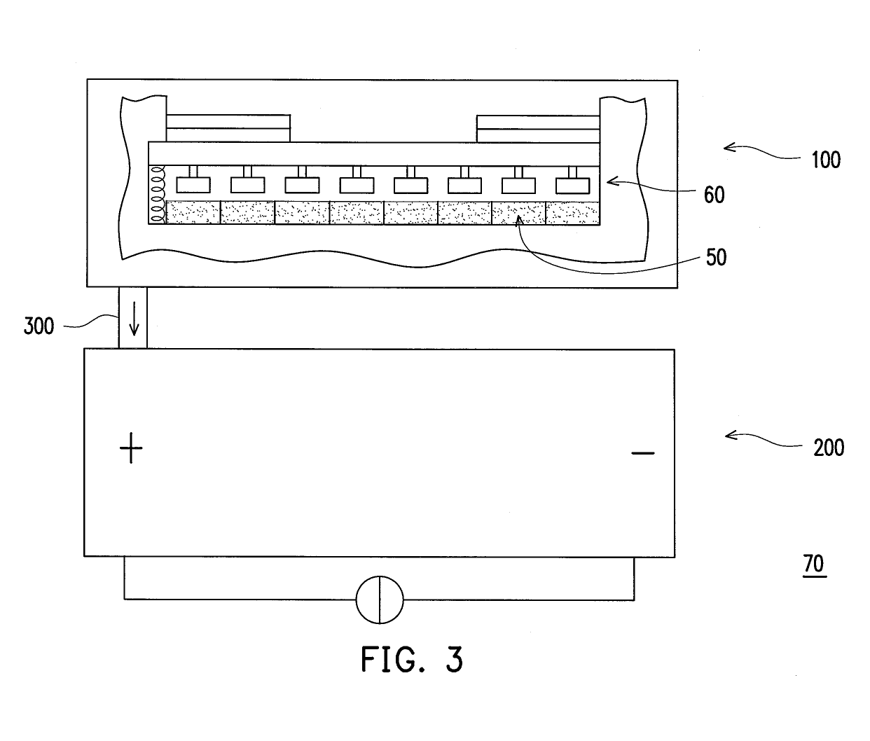

The hydrogen gas generation apparatus 100 of the above embodiments could be used in a fuel cell to supply the hydrogen gas for the fuel cell anodic reaction, as described below with reference to FIG. 3. FIG. 3 illustrates the application of the hydrogen gas generation apparatus of FIG. 1 in a fuel cell. Referring to FIG. 3, the fuel cell 70 includes the hydrogen gas generation apparatus 100 of FIG. 1, a cell stack 200, and a guide structure 300. The guide structure 300 is connected between the hydrogen gas generation apparatus 100 and the cell stack 200 for guiding the hydrogen gas formed by the reaction between the solid fuel 60 and the liquid water 50 to the cell stack 200 to supply the hydrogen gas for the anodic reaction of the cell stack 200. It is noted that oxygen for the cathodic reaction of the cell stack 200 may, for example, be supplied by another source which is well known to those skilled in the art and therefore is not described herein in greater detail. The fuel cell 70 of the embodiment could be used in electronic devices such as notebook computers or mobile phones or transportation such as vehicles or ships.

In summary, the above-described embodiments of the invention have at least one of the following advantages. The sliding member could be moved toward or away from the reserve tank reserving the liquid water under the driving of the bimetallic switch, such that the reaction between the solid fuel fixed to the sliding member and the liquid water could take place to form the hydrogen gas or be halted, thereby achieving a multi-stage reaction. In addition, the reserve tank could be partitioned into a plurality of reserve spaces for reserving the liquid water, and the solid fuel is separated into a plurality of fuel bricks to react with the liquid water in the reserve spaces, respectively, such that the reaction area could be increased to enhance the reaction efficiency.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A hydrogen gas generation apparatus adapted for a fuel cell, comprising:
a main body;
a bimetallic switch having one end connected to the main body;
a reserve tank fixed to the main body and capable of reserving liquid water; and
a sliding member slidably disposed on the main body, wherein a solid fuel is fixed to the sliding member, such that, another end of the bimetallic switch pushes the sliding member toward the reserve tank and the solid fuel reacts with the liquid water in the reserve tank to form hydrogen gas when the bimetallic switch is heated to bend.

2. The hydrogen gas generation apparatus according to claim 1, wherein the bimetallic switch comprises a first metal strip and a second metal strip attached to each other, the material of the first metal strip comprises invar alloy containing 34% to 50% nickel, and the material of the second metal strip comprises at least one of brass, nickel, Fe—Ni—Cr alloy, Fe—Ni—Mn alloy, and Mn—Ni—Cu alloy.

3. The hydrogen gas generation apparatus according to claim 1, wherein the reserve tank is partitioned into a plurality of reserve spaces fluidly isolated from one another, the reserve spaces are capable of reserving the liquid water, the solid fuel comprises a plurality of fuel bricks fixed to the sliding member, and the fuel bricks are capable of respectively moving toward the reserve spaces with the sliding of the sliding member.

4. The hydrogen gas generation apparatus according to claim 3, further comprising a plurality of water absorbing structures disposed in the reserve spaces respectively, and the water absorbing structures is capable of absorbing the liquid water.

5. The hydrogen gas generation apparatus according to claim 1, further comprising an elastic member connected between the main body and the sliding member for providing an elastic force to drive the sliding member to move away from the reserve tank.

6. A fuel cell comprising:
a hydrogen gas generation apparatus comprising:
a main body;
a bimetallic switch having one end connected to the main body;
a reserve tank fixed to the main body and capable of reserving liquid water; and
a sliding member slidably disposed on the main body, wherein a solid fuel is fixed to the sliding member, wherein another end of the bimetallic switch pushes the sliding member toward the reserve tank and the solid fuel reacts with the liquid water in the reserve tank to form hydrogen gas when the bimetallic switch is heated to bend;
a cell stack; and
a guide structure connected between the hydrogen gas generation apparatus and the cell stack and capable of guiding the hydrogen gas formed by the reaction between the solid fuel and the liquid water to the cell stack.

7. The fuel cell according to claim 6, wherein the bimetallic switch comprises a first metal strip and a second metal strip attached to each other, the material of the first metal strip comprises invar alloy containing 34% to 50% nickel, and the material of the second metal strip comprises at least one of brass, nickel, Fe—Ni—Cr alloy, Fe—Ni—Mn alloy, and Mn—Ni—Cu alloy.

8. The fuel cell according to claim 6, wherein the reserve tank is partitioned into a plurality of reserve spaces fluidly isolated from one another, the reserve spaces are capable of reserving the liquid water, the solid fuel comprises a plurality of fuel bricks fixed to the sliding member, and the fuel bricks are capable of respectively moving toward the reserve spaces with the sliding of the sliding member.

9. The fuel cell according to claim 8, wherein the hydrogen gas generation apparatus further comprises a plurality of water absorbing structures disposed in the reserve spaces respectively, and the water absorbing structures are capable of absorbing the liquid water.

10. The fuel cell according to claim 6, further comprising an elastic member connected between the main body and the sliding member for providing an elastic force to drive the sliding member to move away from the reserve tank.
